(19) United States
(12) Patent Application Publication
(10) Pub. No.: US 2021/0278098 A1
(43) Pub. Date: Sep. 9, 2021

(54) Heat Pump Interface

(71) Applicant: Dandelion Energy, Inc., New York, NY (US)

(72) Inventors: Rajeev James Quazi, Hastings-On-Hudson, NY (US); Brian Zimmerly, Brooklyn, NY (US); Ryan Carda, Brookings, SD (US)

(21) Appl. No.: 16/812,119

(22) Filed: Mar. 6, 2020

(51) Int. Cl. F24F 11/30; F25B 30/06; F24F 5/00; F24F 11/63

(52) U.S. Cl. CPC F24F 11/30; F25B 30/06; F25B 2700/21; F24F 11/63; F24F 5/0046

(57) ABSTRACT

A heat pump is equipped with a plurality of sensors configured to measure various physical properties, including but not limited to: (gas/liquid) temperature, (gas/liquid) pressure, electrical current, and/or flow rate. A monitoring center is interposed between the heat pump and other elements of a Heating Ventilation and Air Conditioning (HVAC) system, such as a building thermostat and a heat pump control board. The monitoring center receives the outputs from the sensors and communicates them to a user (e.g., via a wired or wireless interface) for inspection. The monitoring center may also process the sensor data to calculate and output desirable performance metrics such as efficiency and/or available capacity. Where the heat pump is part of a ground source heat pump (GSHP) system or a geothermal heat pump system, embodiments may be particularly useful to also receive and/or process additional sensor input(s) from a flow center component.

### BACKGROUND

Unless otherwise indicated herein, the approaches described in this section are not prior art to the claims in this application and are not admitted to be prior art by inclusion in this section.

Heat pumps are useful for many purposes. One prominent application for a heat pump is as a component for a Heating, Ventilation, and Air Conditioning (HVAC) system used to control ambient temperature within a building.

Heat pumps are complex mechanisms. They can include refrigerant circulation networks comprising conduits, heat exchangers (e.g., coils), valves, and pumps, as well as separate air circulation networks comprising other conduits, heat exchangers, valves, and pumps.

The most familiar types of heat pumps rely upon the outside air to serve as a thermal reservoir. However, other types of heat pumps may instead be coupled to the ground or to a source of geothermal energy. This additional ground flow aspect can contribute further complexity to a heat pump system.

Failed operation of a heat pump can imperil the well being of individuals who are relying upon HVAC systems to maintain a safe ambient temperature. Moreover, inefficient operation of a heat pump can result in excess consumption of input power, undesirably contributing to higher energy costs.

Accordingly, there is a need for an interface with a heat pump that provides detailed reporting regarding system status and performance.

### SUMMARY

A heat pump is equipped with a plurality of sensors configured to measure various physical properties, including but not limited to: (gas/liquid) temperature, (gas/liquid) pressure, electrical current, and/or flow rate. A monitoring center is interposed between the heat pump and other elements of a Heating Ventilation and Air Conditioning (HVAC) system, such as a building thermostat and a heat pump control board. The monitoring center receives the outputs from the sensors and communicates them to a user (e.g., via a wired or wireless interface) for inspection. The monitoring center may also process the sensor data to calculate and output desirable performance metrics such as efficiency and/or available capacity. Where the heat pump is part of a ground source heat pump (GSHP) system or a geothermal heat pump system, embodiments may be particularly useful to also receive and/or process additional sensor input(s) from a flow center component.

### BRIEF DESCRIPTION OF THE DRAWINGS

FIG. 1 shows a simplified diagram of a heat pump system according to an embodiment.

FIG. 2 shows a detailed view of heat pump sensor outputs according to a specific example.

FIG. 3 shows a detailed view of a heat pump control board of a system according to the example.

FIG. 4 shows a detailed view of a flow center according to the example.

FIG. 5 shows a detailed view of a monitoring center according to the example.

FIG. 6 is a simplified view of a data processor and associated memory, showing the inputs thereto and outputs therefrom.

FIG. 7 shows a simplified flow diagram of a method according to an embodiment.

### DETAILED DESCRIPTION

Described herein are methods and apparatuses implementing heat pump monitoring. In the following description, for purposes of explanation, numerous examples and specific details are set forth in order to provide a thorough understanding of embodiments according to the present invention. It will be evident, however, to one skilled in the art that embodiments as defined by the claims may include some or all of the features in these examples alone or in combination with other features described below, and may further include modifications and equivalents of the features and concepts described herein.

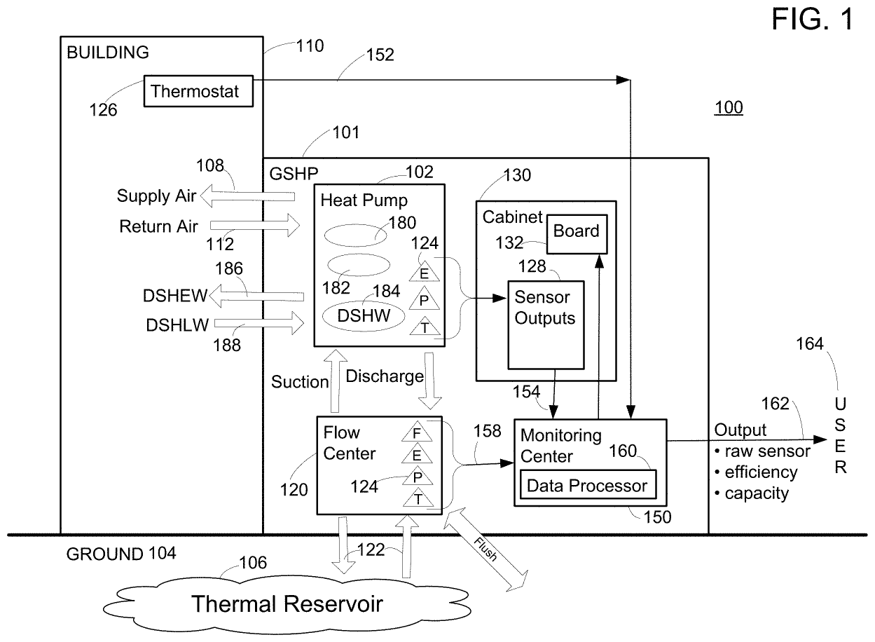

FIG. 1 shows a simplified view of an example system 100 that is configured to implement heat pump monitoring according to an embodiment. Specifically, system 100 comprises a heat pump 102, which may be part of a ground source heat pump (GSHP) system 101. Alternatively, the heat pump may be part of a geothermal heat pump system.

Heat pump 102 may be used in a central heating and/or cooling system that transfers heat to or from the ground 104, which acts as a thermal reservoir 106. The heat pump provides supply air 108 to a building 110, and receives return air 112 from the premises. Heat pump 102 can cool or heat the air received from a return air duct and provide the cooled or heated air to a supply air duct.

The heat pump may include a variety of components. Heat exchanger(s) 180 may comprise water and refrigerant coils. An auxiliary heat component 182 may draw electrical energy to function as a backup and provide additional heating when needed. A domestic hot water (DSHW) system 184 may supply water 186 to the building (e.g., for showering, cleaning), and receive water 188 from the building, at a range of entry and leaving temperatures narrower than that used for thermal management.

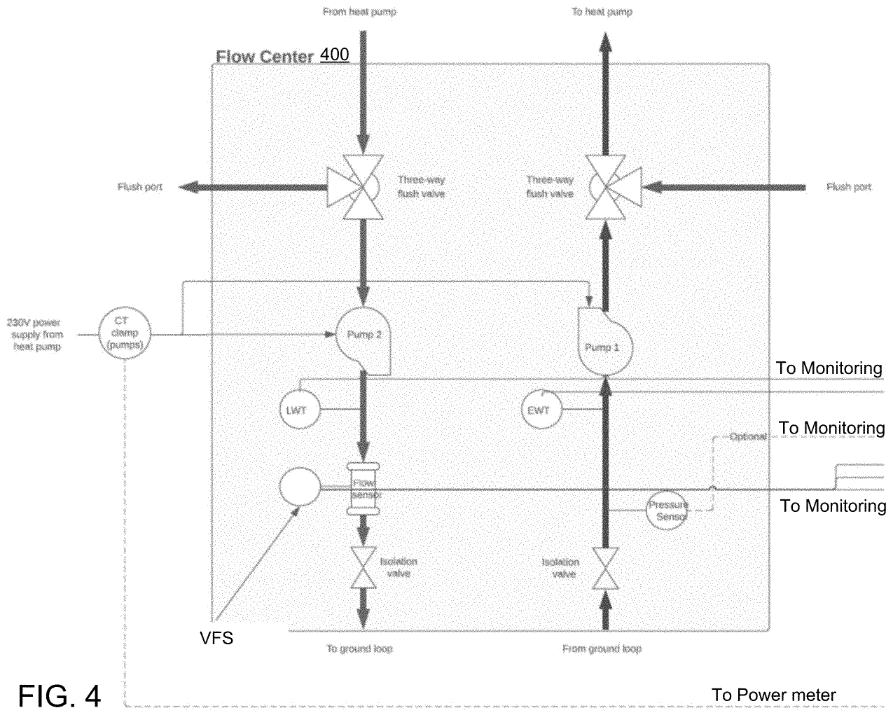

Heat pump 102 uses the ground as a heat source (e.g., in the winter) or a heat sink (e.g., in the summer). The heat pump is in thermal communication with the ground via a flow center 120, which offers suction input 121 to the heat pump, and receives discharge output 123. Details regarding a particular flow center are described later below in connection with FIG. 4 in the example.

A ground loop 122 includes a certain number of bores drilled into the earth to a specified depth. Ground loop 122 circulates a ground loop fluid that is heated or cooled from the ground.

Heat pump 102, flow center 120, and building 110 may be equipped with a variety of different types of sensors 124 that can continuously provide operational data. Examples of such sensors can include but are not limited to those measuring physical properties such as:
temperature (T);
pressure (P);
electrical current and/or potential (E);
flow rate (F); and
humidity (H).

It is noted that certain types of sensors may combine detection of more than one physical property. For example, thermostat 126 can measure both air temperature and humidity within the building.

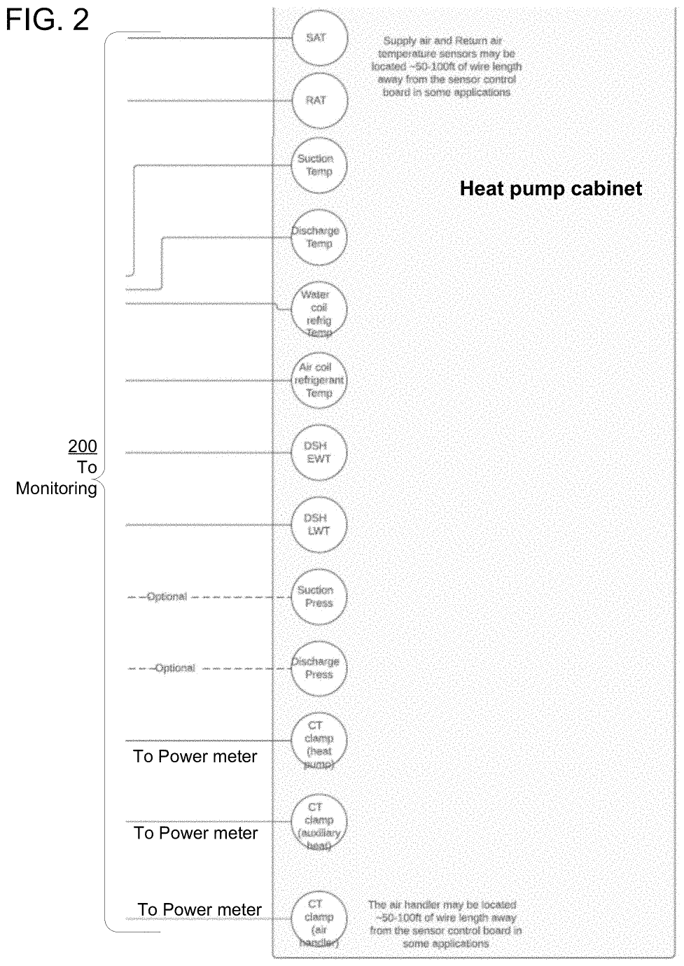

Results from heat pump sensors are compiled in sensor output 128 of the heat pump cabinet 130. Details regarding particular heat pump sensor outputs are described later below in connection with FIG. 2 in the example.

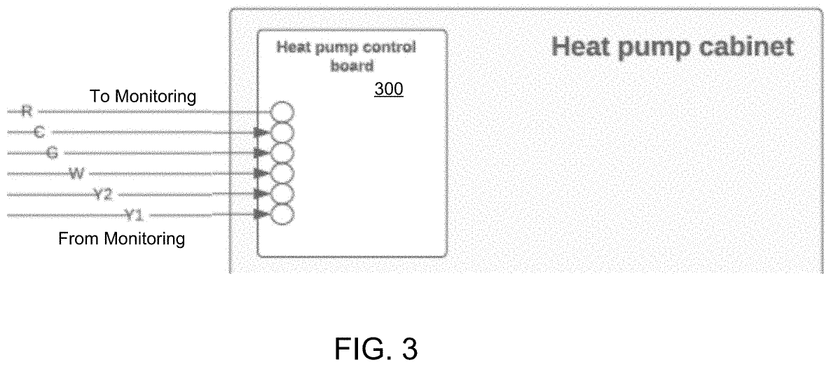

The heat pump cabinet further includes a heat pump control board 132. That control board is configured to receive data from the thermostat. Details regarding a particular heat pump control board are described later below in connection with FIG. 3 of the example.

According to embodiments, the system is further configured to interpose a monitoring center 150 between the thermostat and the control board.

The monitoring center is in communication with inputs from a variety of sources. One set of input data 152 (e.g., temperature and/or humidity of air in the building) is received from the thermostat.

A second set of input data 154 is received from the sensors at the heat pump. These sensor outputs can comprise but are not limited to:
temperature (e.g., of the supply air and/or the return air),
electrical current drawn by the heat pump (e.g., to drive liquid pumps, air fans, sensor activity), and
pressure (of supply/return air).

A third set of input data 158 is received from the sensor outputs of the flow center. These sensor outputs can comprise but are not limited to:
temperature (e.g., of the suction or discharge),
electrical current drawn by the pumps (e.g., to communicate with the ground loop), and
pressure (of the fluid medium flowed through the ground loop), and
flow rate (of the fluid medium flowed through the ground loop).

The monitoring center receives these inputs. The monitoring center further comprises a data processor 160.

The data processor receives the inputs and provide corresponding output(s) 162 to a user 164. Those outputs may include raw or processed data from one or more of the sensors.

The outputs may further comprise the results of performing calculations upon the inputs to provide performance metrics. Examples of such performance metrics can include but are not limited to:
system capacity, and/or
operating efficiency (e.g., of the system as a whole, of the heat pump, or of the flow center only).

Such outputs can afford the user with valuable insight into the state of the complex heat pump system. For example, sensor data can indicate the malfunctioning and possible failure of various system components. Over a longer time scale, the calculated performance metrics can allow operation of the system in a manner that enhances efficiency, reduces power consumption, and lowers cost.

Further details regarding a heat pump interface, are now provided in connection with a particular example involving elements available from Dandelion Energy, Inc., of New York City.

### Example

FIG. 2 shows a detailed view of the heat pump sensor outputs 200 in the heat pump cabinet according to a specific example. These outputs are itemized as follows:
Supply Air Temperature (SAT);
Return Air Temperature (RAT);
Suction Temperature;
Discharge Temperature;
Water coil refrig Temp—temperature of the water in the heat exchanger coil of the heat pump;
Air coil refrigerant Temp—temperature of the refrigerant of the air heat exchanger coil of the heat pump;
Domestic Hot Entry Water Temperature (DSHEWT)—temperature of water entering domestic hot water system and extracted from a heat exchange loop in the heat pump;
Domestic Hot Leaving Water Temperature (DSHLWT)—temperature of water leaving domestic hot water system;
Suction Press—pressure of the medium communicated to the heat pump from the flow center;
Discharge Press—pressure of the medium communicated from the heat pump to the flow center;
CT clamp (heat pump)—amperage of electrical power drawn by the heat pump;
CT clamp (auxiliary heat)—amperage of electrical power drawn by an auxiliary heating component of the heat pump;
CT clamp (air handler)—amperage of electrical power drawn by an air handling component (e.g., fan) of the heat pump.

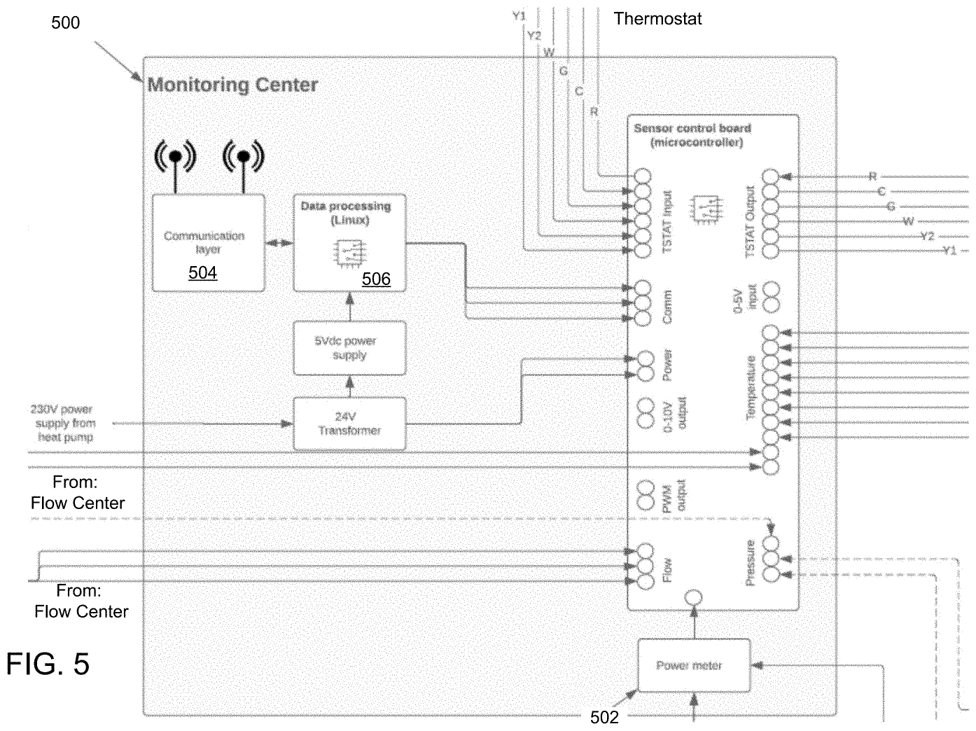

FIG. 3 shows a detailed view of the heat pump control board component 300 of the heat pump control cabinet, of a system according to the example. This control board is configured to receive standard inputs from a thermostat, and to provide an output to the thermostat, via the monitoring center (described below in connection with FIG. 5).

FIG. 4 shows a detailed view of a flow center 400 according to the example. This flow center embodiment includes three-way flush valves and ports that allow for flushing the flow center when desired. Also, a Vortex Flow Sensor (VFS) available from Grundfos of Bjerringbro, Denmark, may measure both flow rate and temperature. In this exemplary flow center, provision is made for sensors to measure both Entry Water Temperature (EWT) and Leaving Water Temperature (LWT).

FIG. 5 shows a detailed view of a monitoring center according to the example. As shown, the monitoring center receives various inputs from the thermostat, the flow center, and the heat pump (via the outputs). The monitoring center includes a power meter 502 for determining electrical power from current (clamp) sensors.

The communication layer 504 affords wireless communication with a user. In this particular example, the data processing is performed by data processor 506 operating according the Linux operating system (OS). However, neither this nor any other particular operating system is required to be used.

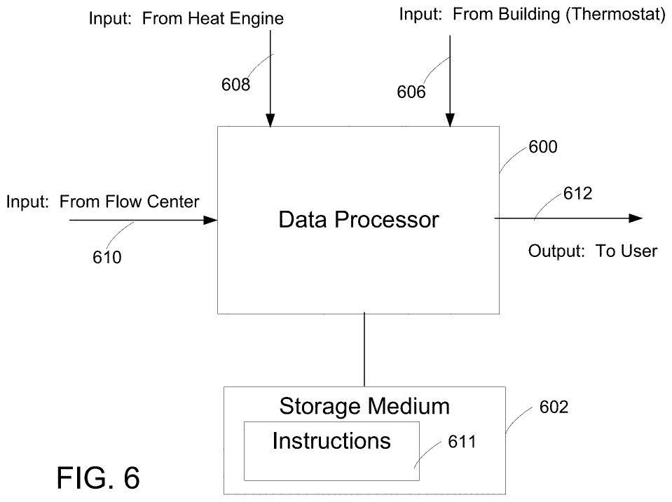

Returning now to an overview of the system, FIG. 6 is a simplified view of a data processor 600 and associated non-transitory computer readable storage medium 602, showing the inputs thereto. In particular, the data processor of the monitoring center may receive sensor inputs 606, 608, and 610 from various sources, such as a thermostat, a heat pump, and a flow center respectively.

Based upon instructions 611 in the form of executable code present in the non-transitory computer-readable storage medium, the data processor may calculate performance metric(s) for the system, and provide those metrics as outputs 612 for review by a user.

The following are sample calculations for heating mode operation. Heating performance is generally defined by heating capacity (HC), electricity consumption (DMD) and efficiency (COP), which are calculated using Equations (1)-(4).

$$HE = GPM \cdot ( EWT - LWT ) \cdot ρ \cdot {C}_{p} \cdot \frac{60 min}{hr} \cdot \frac{{ft}^{3}}{7.48 gal} \qquad ( 1 )$$

where:
HE=heat of extraction from the ground loop, Btu/hr
GPM=ground loop water flow rate, gal/min
EWT=entering water temperature (entering heat pump from the ground loop), ° F.
LWT=leaving water temperature (leaving heat pump, returning to the ground loop), ° F.
ρ=density of the circulating fluid at average water temperature, lb/ft³
Cₚ=specific heat of the circulating fluid at average water temperature, Btu/lb-° F.

DMD=V·I·PF (2)

where:
DMD=electric demand, W
V=voltage supplied to heat pump, Volts
I=current through heat pump, Amps
Power factor, dimensionless

$$H C = \frac{3.4 \; 12 Btu}{W} \cdot DMD + HE \qquad ( 3 )$$

where:
HC=heating capacity, Btu/hr
DMD=electric demand, W
HE=heat of extraction from the ground loop, Btu/hr

$$C O P = \frac{H C}{3 .412 \cdot DMD} \qquad ( 4 )$$

where:
COP=coefficient of performance, a measure of heating efficiency, dimensionless
HC=heating capacity, Btu/hr
DMD=electric demand, W

The above equations (1)-(4) can be used to define the heating performance of a heat pump on an instantaneous basis through sampling. They can also be used to quantify system performance, total power consumption, total energy delivered to the, etc. over a period of time (e.g. on a weekly, monthly, seasonal or annual basis) by multiplying the instantaneous readings by the amount of time elapsed between readings, and then summing and/or averaging those values over the same time period.

Sample calculations for cooling mode operation are now described. In particular, cooling performance is generally defined by total cooling capacity (TC), electricity consumption (DMD) and efficiency (EER), which are calculated using the following equations (5)-(8):

$$H R = GPM \cdot ( LWT - EWT ) \cdot ρ \cdot {C}_{p} \cdot \frac{60 min}{h r} \cdot \frac{{ft}^{{ }^{3}}}{7.48 gal} \qquad ( 5 )$$

where:
HR=heat of rejection to the ground loop, Btu/hr
GPM=ground loop water flow rate, gal/min
LWT=leaving water temperature (leaving heat pump, returning to the ground loop), ° F.
EWT=entering water temperature (entering heat pump from the ground loop), ° F.
p=density of the circulating fluid at average water temperature, lb/ft³
Cₚ=specific heat of the circulating fluid at average water temperature, Btu/lb-° F.

DMD=V·I·PF (6)

where:
DMD=electric demand, W
V=voltage supplied to heat pump, Volts
I=current through heat pump, Amps
Power factor, dimensionless

$$T C = H R - \frac{3.4 \; 12 Btu}{W} \cdot DMD \qquad ( 7 )$$

where:
TC=total cooling capacity, Btu/hr
DMD=electric demand, W
HR=heat of rejection to the ground loop, Btu/hr

$$E E R = \frac{T C}{D M D} \qquad ( 8 )$$

where:
EER=energy efficiency ratio, a measure of cooling efficiency, Btu/W-hr
TC=total cooling capacity, Btu/hr
DMD=electric demand, W

Equations (5)-(8) can be used to define the cooling performance of a heat pump on an instantaneous basis through sampling. They can also be used to quantify system performance, total power consumption, total energy rejected from the space, etc. over a period of time (e.g. on a weekly, monthly, seasonal or annual basis) by multiplying the instantaneous readings by the amount of time elapsed between readings, and then summing and/or averaging those values over the same time period.

Sample calculations for various heat pump operating parameters are now described. Monitoring data can also be used to verify various aspects of system performance are within expected range. For example, proper airflow is critical to the performance of a heat pump. The nominal airflow for a heat pump is typically 400 cfm per ton (of capacity). Insufficient airflow can lead to issues with the refrigeration circuit, and improper comfort in the space. Airflow through a heat pump can be calculated using equations (9)-(10) below.

$$C F {M}_{htg} = \frac{HC \cdot v}{60 min \text{/} hr \cdot ( {h}_{l a} - {h}_{e a} )} \qquad ( 9 )$$

where:
CFM_{htg}=airflow rate in heating mode, ft³/min
HC=heating capacity of the heat pump, Btu/hr
ν=specific volume of air at average temperature, ft³/lb_{da}
hₗₐ=specific enthalpy of leaving air at measured temperature and relative humidity (from heat pump), Btu/lb_{da}
hₑₐ=specific enthalpy of entering air at measured temperature and relative humidity (into heat pump), Btu/lb_{da}

$$C F {M}_{c l g} = \frac{SC \cdot v}{60 min \text{/} hr \cdot ( {h}_{e a} - {h}_{l a} )} \qquad ( 10 )$$

where:
CFM_{clg}=airflow rate through heat pump in cooling mode, ft³/min
SC=sensible cooling capacity of the heat pump, Btu/hr
ν=specific volume of air at average temperature, ft³/lb_{da}
hₑₐ=specific enthalpy of entering air at measured temperature and relative humidity (into heat pump), Btu/lb_{da}
hₗₐ=specific enthalpy of leaving air at measured temperature and relative humidity (from heat pump), Btu/lb_{da}

Superheat and subcooling are parameters that are used to ensure that the heat pump refrigeration circuit is operating as it should.

Superheat occurs when refrigerant vapor is heated above its boiling point. In the refrigeration process, superheat ensures that vapor enters the compressor after accounting for inefficiency/loss in the refrigeration circuit. If liquid enters the compressor, damage can occur.

Subcooling occurs when liquid refrigerant is cooled below its dew point. In the refrigeration process, subcooling ensures that liquid enters the expansion device after accounting for inefficiency/loss in the refrigeration circuit. If vapor enters the expansion, damage can occur.

The amount of superheat and subcool can be calculated using equation (11) and (12) respectively below.

Superheat=T_{suction}−T_{sat,v} (11)

where:
T_{suction}=temperature of the vapor refrigerant leaving the evaporator coil, ° F.
T_{sat,b}=saturation temperature of the refrigerant at the suction pressure of the compressor, ° F.

Subcooling=T_{sat,l}−T_{liquid} (12)

where:
T_{sat,c}=saturation temperature of the refrigerant at the liquid line pressure, ° F.
Tₑᵥₐₚ=temperature of the liquid refrigerant leaving the condenser, prior to entering the expansion valve, ° F.

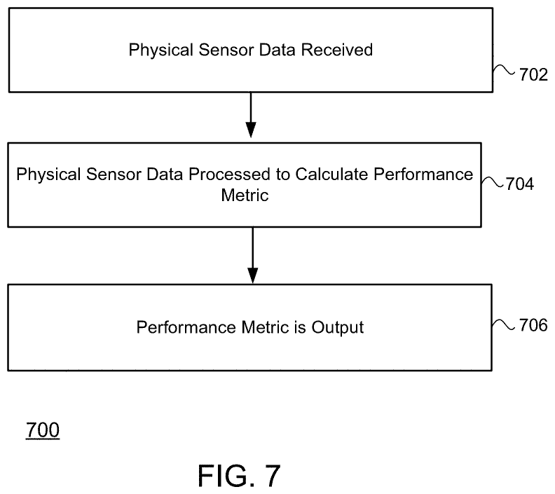

FIG. 7 shows a simplified flow diagram of a method 700 according to an embodiment. At 702, an input is received from a physical sensor of a heat pump.

At 704, the input is processed by instructions stored in a non-transitory computer readable storage medium to calculate a performance metric. Exemplary performance metrics can include but are not limited to, efficiency and capacity.

At 706, the calculated performance metric is communicated as output. The output may be communicated on a wireless or wired communication channel.

Embodiments may offer certain benefits over conventional approaches. For example, certain embodiments may implement the monitoring center between existing components of a system, e.g., a thermostat provided, and a heat pump having one or more physical sensor(s).

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. An apparatus comprising:
a heat pump equipped with a first physical sensor and with a second physical sensor;
a heat pump control board; and
a processor interposed between the heat pump and the heat pump control board, the processor configured to,
receive a first input from the first physical sensor,
receive a second input from the second physical sensor,
calculate a heat pump performance metric from the first input and the second input, and
output the heat pump performance metric to a communication channel.

2. An apparatus as in claim 1 wherein the processor is further configured to calculate the performance metric from a third input from a flow center in fluid communication with the heat pump.

3. An apparatus as in claim 2 wherein the heat pump comprises a ground source heat pump (GSHP).

4. An apparatus as in claim 2 wherein the heat pump comprises a geothermal heat pump.

5. An apparatus as in claim 1 wherein the processor is interposed between the heat pump and a thermostat.

6. An apparatus as in claim 1 wherein the performance metric comprises an efficiency.

7. An apparatus as in claim 1 wherein the performance metric comprises a capacity.

8. An apparatus as in claim 1 wherein:
the first sensor is configured to detect a gas temperature; and
the second sensor is configured to detect other than a gas temperature.

9. An apparatus as in claim 1 wherein the communication channel is a wireless communication channel.

10. A non-transitory computer readable storage medium embodying a computer program for performing a method, said method comprising:
receiving a first input from a first physical sensor in communication with a heat pump;
receiving a second input from a second physical sensor in communication with the heat pump;
processing the first input and the second input to calculate a performance metric; and
outputting the performance metric to a communication channel.

11. A non-transitory computer readable storage medium as in claim 9 wherein:
the heat pump is a ground source heat pump (GSHP) or a geothermal heat pump in fluid communication with a flow center; and
the method further comprises,
receiving a third input from a third physical sensor of the flow center; and
calculating the performance metric from the first input, the second input, and the third input.

12. A non-transitory computer readable storage medium as in claim 9 wherein the method further comprises:
receiving a third input from a thermostat; and
calculating the performance metric from the first input, the second input, and the third input.

13. A non-transitory computer readable storage medium as in claim 9 wherein:
the first input comprises a gas temperature; and
the second input comprises other than a gas temperature.

14. A non-transitory computer readable storage medium as in claim 9 wherein the performance metric comprises an efficiency or a capacity.

15. A computer system comprising:
a processor;
a software program, executable on said computer system, the software program configured to cause the processor to:
receive a first input from a first sensor of a heat pump;
receive a second input from a second sensor of a flow center in fluid communication with the heat pump;
process the first input and the second input to calculate a performance metric; and
output the performance metric to a communication channel.

16. A computer system as in claim 15 wherein:
the heat pump comprises a ground source heat pump; and
the flow center is in fluid communication with the ground to serve as a thermal reservoir.

17. A computer system as in claim 15 wherein:
the heat pump comprises a geothermal heat pump; and
the flow center is in fluid communication with a source of geothermal energy to serve as a thermal reservoir.

18. A computer system as in claim 15 wherein the performance metric comprises an efficiency or a capacity.

19. A computer system as in claim 15 wherein the first input indicates a temperature.

20. A computer system as in claim 15 wherein the second input indicates a pressure, a flow rate, or a current.
